(19) United States
(12) Patent Application Publication
(10) Pub. No.: US 2004/0112878 A1
(43) Pub. Date: Jun. 17, 2004

(54) Method and apparatus for making a minute product using uv laser beam

(76) Inventors: Kyung-ku Yoon, Surrey (CA); Be-Sung Shin, Daejeon-City (KR); Doo-Sun Choi, Daejeon-City (KR); Seong-Kuk Lee, Vaughan Ontario (CA); Jae-Ku Kim, Daejeon-City (KR); Kyung-Hyun Whang, Daejeon-City (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/432,641

(22) PCT Filed: Jun. 12, 2001
(86) PCT No.: PCT/KR01/01004

(30) Foreign Application Priority Data
Jun. 12, 2000 (KR) 2000/32176

(51) Int. Cl. B23K 26/36

(52) U.S. Cl. 219/121.69

(57) ABSTRACT

Method for making a minute product by using laser beam. A workpiece is mounted on a mounting device. The laser beam is irradiated to a pre-selected portion of the workpiece for ablation. The space formed during the ablation is filled with filler. The other portion of the workpiece is ablated for making the workpiece to have a predetermined shape. The filler is removed from the shaped workpiece to provide the minute product.

### TECHINAL FIELD

The present invention relates to a method and apparatus for manufacturing a minute product using UV laser beams.

### BACKGROUND ART

A three-dimensional minute product means a product being of a size within a range of several microns (μm) to several millimeters (mm). The minute product is also referred to as an extremely small product in view of their size. The minute product has complicated geometrical configurations, and manufacturing precision thereof is also very strictly required.

There are several conventional making methods for manufacturing such a minute product, such as LIGA (which is an abbreviation of a German terminology, i.e., Lithographi, Galvanoformung Abformung, and means deep-etch lithography, electroforming and molding), silicon surface micro machining, silicon bulk micro machining, electro-discharge machining (EDM), and the like.

These methods are complicated in view of their processes. In order to manufacture the minute product, a multitude of processes using various kinds of equipment need to be performed. These methods have their limitations in view of perfect three-dimensional manufacturing. Precisely speaking, the product manufactured by these methods only has a 2.5-dimensional shape. These methods still have problems in that they are not suitable for prototype manufacture or job shop production and in that they may cause environmental problems.

### SUMMARY OF THE INVENTION

An object of the present invention is to provide a method for manufacturing a three-dimensional minute product upon prototype manufacture or job shop production.

Another object of the present invention is to provide a method for manufacturing a minute product, in which the minute product is manufactured to have a three-dimensional shape using laser beams and of which the processes are simple.

In order to achieve the above objects, a method for manufacturing a minute product by machining a workpiece with laser beams according to the present invention comprises the steps of mounting the workpiece to a feeding device; irradiating the laser beams onto a pre-selected portion of the workpiece for ablation thereof; filling a space, which has been formed by ablating the pre-selected portion of the workpiece, with a filler; forming a predetermined shape of the minute product by ablating other portions of the workpiece; and separating the finished minute product from the filler.

According to another aspect of the present invention, there is provided a method for manufacturing a minute product by machining a workpiece with laser beams, comprising the steps of mounting the workpiece to a feeding device; irradiating the laser beams onto a pre-selected portion of the workpiece for ablation thereof; filling a space, which has been formed by ablating the pre-selected portion of the workpiece, with a filler; forming a predetermined shape of the minute product by ablating the filler; and separating the finished minute product made of the filler from a remaining portion of the workpiece.

### BRIEF DESCRIPTION OF THE DRAWINGS

The above and other objects and features of the present invention will become apparent to a person skilled in the art from the following description of preferred embodiments given in connection with the accompanying drawings, in which:

FIG. 1 is a graph of test results illustrating the three-dimensional processing principle for a minute product;

FIG. 2 is a constitutional view of an apparatus for manufacturing the minute product according to an embodiment of the present invention;

FIGS. 3a to 3c are perspective views showing several examples of worktables for installing and mounting workpieces which will be used in the apparatus for manufacturing the minute product according to an embodiment of the present invention;

FIGS. 4a and 4b are a perspective view and a sectional view of the minute product (aspherical lens) that will be manufactured by a method according to an embodiment of the present invention, respectively; and

FIGS. 5a to 5e are views showing the processes for manufacturing the aspherical lens by the manufacturing method according to the embodiment of the present invention.

### DETAILED DESCRIPTION OF THE PREFERRED EMBODIMENTS

It is preferred that laser beams from a UV laser are used in the present invention. UV laser is referred to as an invisible laser having a wavelength of about 400 nm to 10 nm. As examples of [the] UV lasers, the following can be used.

(1) Nd:YAG laser

Frequency-tripled Nd:YAG laser (wavelength: 355 nm)

Frequency-quadrupled Nd:YAG laser (wavelength: 266 nm)

(2) Nd:YLF laser

Frequency-tripled Nd:YLF laser (wavelength: 351 nm)

Frequency-quadrupled Nd:YLF laser (wavelength: 349 nm)

(3) Nd:Glass laser

Frequency-tripled Nd:Glass laser (wavelength: 355 nm)

(4) Excimer laser

KrF Excimer laser (wavelength: 249 nm)

ArF Excimer laser (wavelength: 191 nm)

XeCl Excimer laser (wavelength: 308 nm)

XeF Excimer laser (wavelength: 351 nm)

(5) Helium-Cadmium laser

Helium-Cadmium laser (wavelength: 324 nm)

(6) Argon laser

Argon laser (wavelength: 333.6 to 363.8 nm)

(7) Krypton laser

Krypton laser (wavelength: 337.5 to 356.4 nm)

Contrary to the visible ray laser or infrared laser, any heat-affecting portion in the neighborhood of a boundary of the machined surface is not produced in the lasers oscillated at these ultraviolet regions. Therefore, depth control for the three-dimensional product can be made by controlling the machining pulses. For this reason, it is preferred that the UV laser be used when manufacturing the minute product.

Among the UV lasers, an Excimer laser is more preferable. The Excimer laser has short pulse duration, a high peak power, and superior connectivity and uniformity. Further, by using the Excimer laser, a process for eliminating a metal thin layer can be performed within the atmosphere.

Hereinafter, preferred embodiments of the present invention will be explained in detail with reference to the accompanying drawings.

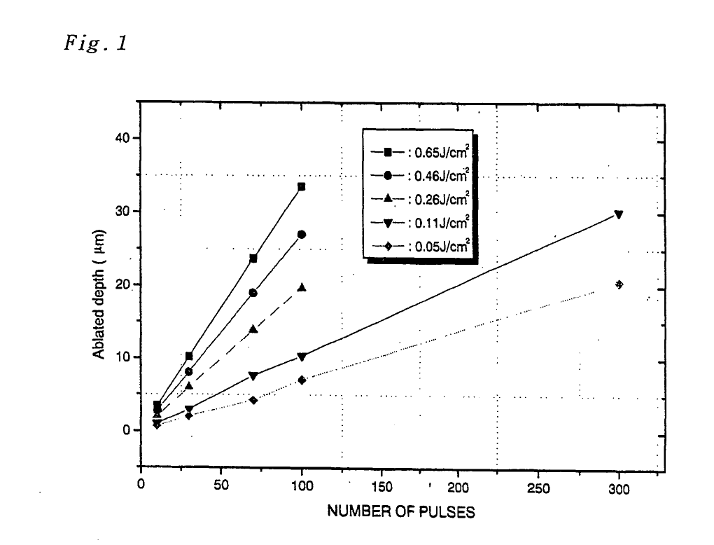

FIG. 1 is a view showing the relationship between the power of the laser, number of pulses, and ablated depth while processing the product using the Excimer laser. It is understood from FIG. 1 that the ablated depth is proportional to the number of pulses regardless of the power of the laser. Consequently, it is understood that the laser beam processing of the product can be performed by controlling the number of pulses. Accordingly, the present inventor has invented a method for manufacturing the minute product using an ablation function of the Excimer laser.

A brief description of the manufacturing process according to the present invention is as follows. \mathring{1} The raw stock is fixed. \mathring{2} The first surface of the stock is ablated. \mathring{3} The first ablated surface is filled with a filler. \mathring{4} The second surface of the stock is positioned in a laser scanning direction. \mathring{5} The ablation process (step \mathring{2}) and the filling process (step \mathring{3}) which have been performed are repeated. \mathring{6}The filler or stock is separated from each other. (\mathring{7} The processed product is finishprocessed (post-processed) in order to obtain the finished minute product.

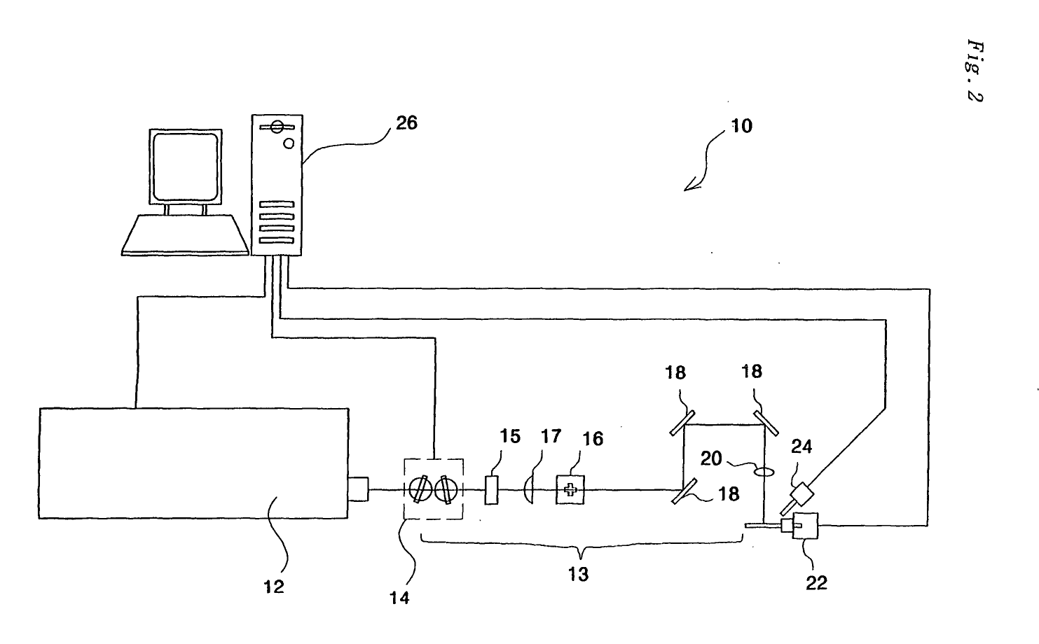

Referring to FIG. 2, there is shown a machining system 10 for manufacturing the minute product. The laser machining system 10 is provided with a laser oscillator 12 in a laser beam progression direction. Further, the system 10 includes an optical system 13 for controlling, adjusting and projecting the laser beams.

The optical system 13 comprises a beam attenuator 14 and a beam homogenizer 15. A field lens 17 and a mask 16 are disposed downstream of the beam homogenizer. Mirrors 18 for changing the laser beam direction and an image lens 20 are disposed downstream of the mask 16. The laser machining system 10 includes a workpiece feeder 22 in which the stock is installed or mounted. A camera 24 for monitoring a machining state of the workpiece is also provided. A system controller 26 is connected to the laser oscillator 12, the beam attenuator 14, the monitoring camera 24 and the workpiece mounting device 22 in order to monitor and control their operations.

The laser oscillator 12 is an Excimer laser oscillator. There are various combinations of the media which is oscillated by using Excimer transition. However, a mixture in which extremely small quantities of rare element gas (e.g., Ar, Kr, Xe) and halogen gas (e.g., F, Cl) are mixed in dilution gas (N or He) is generally used for the Excimer laser. When the Excimer laser is generated, the duration of the electric discharge is about several tens of nanoseconds (ns) and an oscillating time of the laser is very short since it is around 20 nanoseconds. However, pulse energy is relatively large since it is about several hundreds of mJ.

All varieties of Excimer lasers can be used in the present invention, and preferably, a KrF Excimer laser is used as a light source. The KrF laser can sufficiently provide a predetermined resolution needed in machining the fine configuration since it has a short wavelength. Furthermore, the shape of the beam oscillated from the laser is rectangular, and the power density thereof is uniform to some degree. Thus, the optical system becomes simplified.

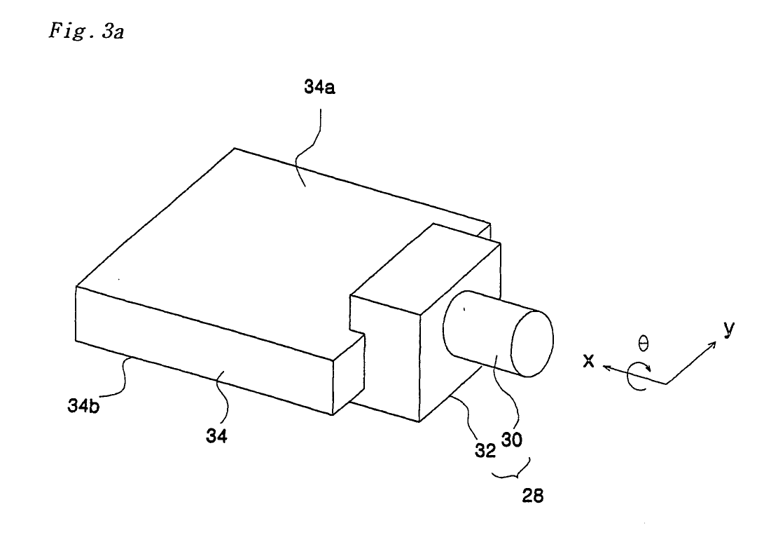

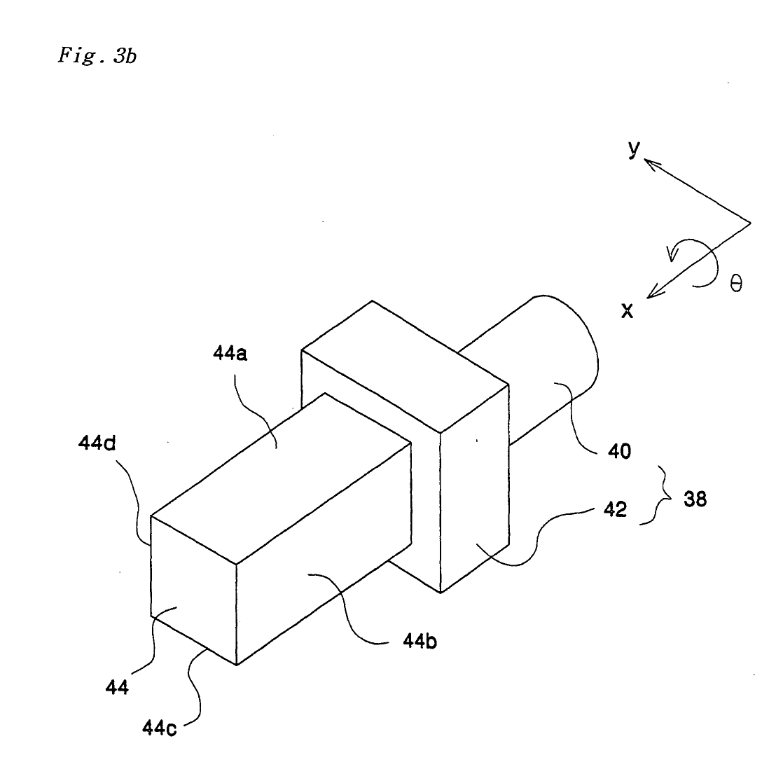

Any conventional device for linearly or rotationally (self-rotationally) moving the stock can be used as the workpiece feeder 22. Referring to FIG. 3a, there is shown a jig 28 to be mounted to the workpiece feeder 22. The jig 28 includes a workpiece fixing portion 32 and a rotating shaft portion 30 that is fixed to a drive shaft portion of the workpiece feeder 22. A workpiece 34 is fixed to the workpiece fixing portion 32. Referring to FIG. 3a, upper and lower surfaces 34a, 34b of the workpiece 34 are machined. First, the workpiece feeder 22 causes the upper surface 34a of the workpiece 34 to move along the x- and y-axes. After the machining of the upper surface 34a has been completed, the workpiece 34 is rotated 180 degrees about the rotating shaft portion 30. Then, the other surface 34b is machined while moving along the x- and y-axes.

Referring to FIG. 3b, there is shown another jig 38 that is mounted to the workpiece feeder 22. The jig 38 includes a workpiece fixing portion 42 and a rotating shaft portion 40 that is fixed to the drive shaft portion of the workpiece feeder 22. A workpiece 44 is fixed to the workpiece fixing portion 42. Referring to FIG. 3b, four surfaces 44a, 44b, 44c and 44d of the workpiece 44, which form angles of 90 degrees with each other, are machined. First, the workpiece feeder 22 causes the first surface 44a of the workpiece 44 to move along the x- and y-axes. After the machining of the first surface 44a has been completed, the workpiece 44 is rotated 90 degrees about the rotating shaft portion 40. Then, the processes for machining and rotating the other surfaces 44b, 44c and 44d in sequence are repeated in order to machine the workpiece.

Referring to FIG. 3c, there is shown a further jig 48 that is mounted to the workpiece feeder 22. The jig 48 includes a workpiece fixing portion 52 and a rotating shaft portion 50 that is fixed to the drive shaft portion of the workpiece feeder 22. The workpiece fixing portion 52 is provided with jaws 52a. A cylindrical workpiece 54 is fixed to the workpiece fixing portion 52 by means of the jaws 52a. Referring to FIG. 3c, the workpiece 54 is machined while rotating and moving the workpiece about and along the x-axis.

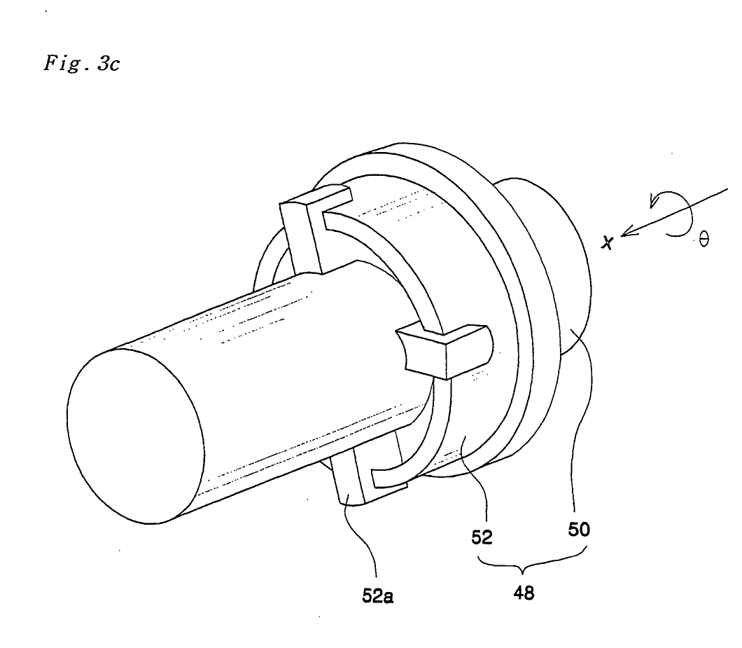

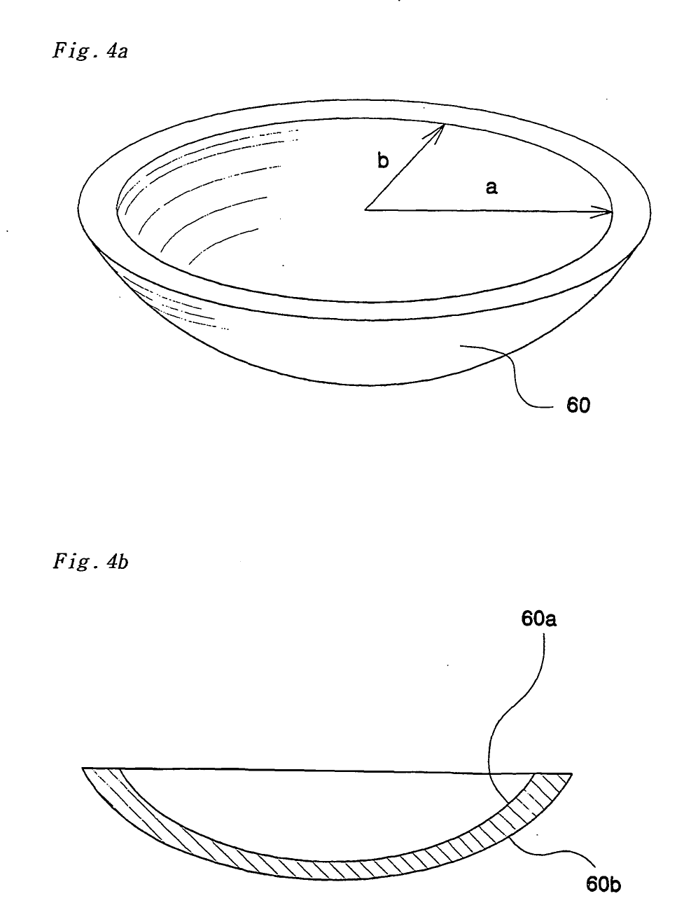

Referring to FIGS. 4a and 4b, an aspherical lens 60 is shown as an example of the minute product to be machined. Both surfaces of the lens 60 take the shape of the aspherical surfaces. Furthermore, an outer brim is in the form of an ellipse, in which the distance between the center of the major axis radius a and the brim is different from that between a center of a minor axis radius b and the brim. Both surfaces 60a, 60b of the lens have curvatures different from each other, and are also aspherical. Data on the three-dimensional coordinates of the surfaces of the lens 60 to be machined can be obtained upon design of the lens. In order to facilitate understanding of the present invention, the aspherical lens 60 exemplifies the minute product according to the present invention. Therefore, the present invention is not limited to the manufacture of the aforementioned lens. It is a matter of course that the other minute products having different configurations can also be manufactured according to the manufacturing method of the present invention.

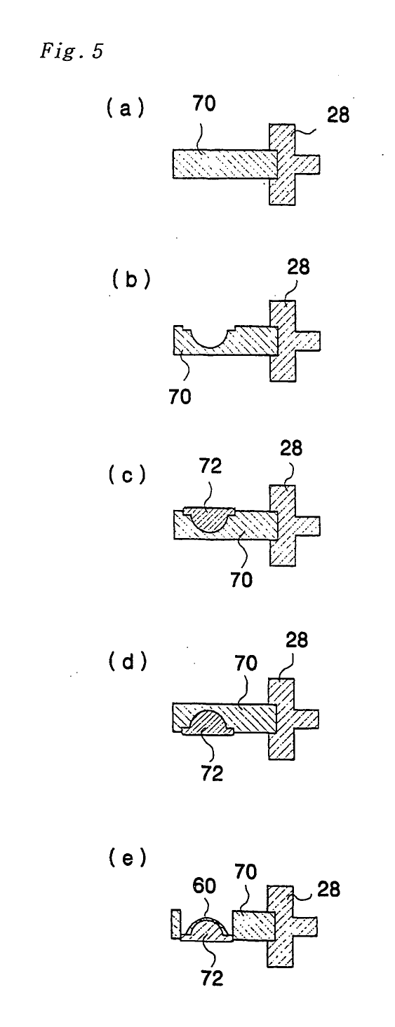

Referring to FIG. 5, a method for manufacturing the lens 60 of FIG. 4 according to a preferred embodiment of the present invention is explained. As shown in FIG. 5a, a workpiece 70 is fixed to the workpiece feeder using the jig 28 shown in FIG. 3a. For example, the workpiece 70 is made of transparent plastic resin such as acrylic resin for use in the lens. As previously described with reference to FIGS. 1 and 2, one laser beam which has passed through the mask 16 allows the workpiece to be machined by a predetermined depth in accordance with laser pulses and amount of energy thereof. The workpiece, i.e. the feeder 22 with the workpiece 70 mounted thereon, is controlled by the position controller 26. At this time, the workpiece 70 is synchronized with the laser oscillator by means of the controller 26 for directing the feeding (i.e., position) of the workpiece.

First, the laser machining system 10 is operated. Then, the laser optical system 13 is adjusted, and the mask 16 is precisely positioned and controlled so that the maximum intensity of the laser beam passing through the mask can be obtained. As shown in FIG. 5b, a predetermined region within the first surface to be machined is ablated while controlling the position of the workpiece 70. At this time, the position of the workpiece 70 is synchronized with the laser pulses, and the workpiece 70 is then laser machined. Thus, a perfect three-dimensional machining can be made since the machining position has been synchronized with the laser pulses when machining the workpiece. As shown in FIG. 5c, the machined space on a side of the machined surface is filled with the filler. At this point, the filler 72 is made of a resin with a melting temperature lower than that of the plastic resin used for the workpiece 70. For example, resin such as soluble support resin, which is soluble in water at room temperature may be used.

As shown in FIG. 5d, the workpiece 70 mounted on the feeder is again rotated 180 degrees. So as to place the second surface to be machined as the surface to be laser scanned, the workpiece is rotated by and fixed to the jig 28. Then, the second surface is ablated as like the process shown in FIG. 5c. Thus, all the surfaces to be machined are ablated. During ablation, the workpiece 70 is machined in the form of the lens 60. Thereafter, the lens 60 is brought to completion as a finished product by separating the filler therefrom. In a case where the aforementioned soluble support resin is used for the filler, the finished lens 60 can be separated from the filler by dissolving the filler in the water. The filler used in the above preferred embodiment of the present invention can perform its role for maintaining a predetermined shape of the workpiece until the machining process is completed.

In the above embodiment, it has been described that resins whose melting temperatures are different from each other are used for the workpiece 70 and the filler 72. However, metallic materials such as nickel, copper and the like may be used for the filler in alternative embodiments. The metallic material is filled by a method such as electroplating. In this case, if the workpiece and the filler are separated from each other by melting them, the workpiece is first melted and the filler remains. Then, a mold core can be manufactured by machining the filler. Thus, a minute product, which is the same as the workpiece, can be formed by means of the mold in which the machined filler has been used as the mold core.

According to the preferred embodiments described above, the workpiece 70 is formed into the minute product. However, unlike the aforementioned embodiments, the filler may be used as a material for manufacturing the minute product. In such a case, the jig with the workpiece mounted thereon should be placed such that a surface filled with the filler is exposed directly toward the laser beam. If the filler has been formed into a predetermined shape of the minute product, the firstly mounted workpiece is melted and separated from the filler. Thus, the minute product formed of the filler material can be obtained.

Alternatively, the filler and the workpiece may be easily separated from each other by the methods other than the melting. For example, in the embodiment described above, a chemical substance for separation (generally, referred to as a mold release or parting agent) may be applied between the filler and a surface of the workpiece where the lens will be formed before filling with the filler. Thus, the finished lens can be easily separated from the filler later.

According to the constitution of the present invention, the three-dimensional minute product can be machined by use of the laser beam. In particular, the manufacturing method of the present invention is preferably used upon prototype manufacture or job shop production. Therefore, the process for manufacturing the three-dimensional minute product can be simplified, and the three-dimensional minute product can be manufactured without additional molds. Furthermore, if the jigs according to the present invention are used, each surface of the minute product can be easily machined, and thus, the three-dimensional minute product can be easily manufactured.

While the invention has been shown and described with respect to the preferred embodiments, it will be understood by a person skilled in the art that various changes and modifications may be made without departing from the spirit and scope of the invention as defined in the following claims and may fall within the scope of the present invention.

1. A method for manufacturing a minute product by machining a workpiece with laser beams, comprising the steps of:
mounting said workpiece to a feeding device;
irradiating said laser beams onto a pre-selected portion of said workpiece for ablation thereof;
filling a space, which has been formed by ablating said pre-selected portion of said workpiece, with a filler;
forming a predetermined shape of said minute product by ablating other portions of said workpiece; and
separating said finished minute product from said filler.

2. A method for manufacturing a minute product by machining a workpiece with laser beams, comprising the steps of:
mounting said workpiece to a feeding device;
irradiating said laser beams onto a pre-selected portion of said workpiece for ablation thereof;
filling a space, which has been formed by ablating said pre-selected portion of said workpiece, with a filler;
forming a predetermined shape of said minute product by ablating said filler; and
separating said finished minute product made of said filler from a remaining portion of said workpiece.

3. The method as claimed in claim 1 or 2, wherein movement of said workpiece by means of said feeding device is synchronized with oscillation of said laser beams.

4. The method as claimed in claim 1 or 2, wherein a laser is an Excimer laser and the machining depth of said workpiece can be controlled by pulses or energy of said laser.

5. An apparatus for manufacturing a minute product using a laser, comprising:
a laser oscillator;
an optical system for controlling laser beams; and
a workpiece feeding device,
wherein said workpiece feeding device allows said workpiece to be fed linearly or rotationally so that laser oscillation of said laser oscillator is synchronized with said movement of said workpiece, and
a jig mounted to said feeding device includes a rotating shaft portion engaged with said feeding device and a workpiece fixing portion for holding said workpiece.
